(19) United States
(12) Patent Application Publication
(10) Pub. No.: US 2014/0156391 A1
(43) Pub. Date: Jun. 5, 2014

(54) PUBLISHING INFORMATION FOR AVAILABLE PRODUCTS AND SERVICES WITHIN PRIVATE NETWORKS

(71) Applicant: Julien Neri, Dublin (IE)

(72) Inventor: Julien Neri, Dublin (IE)

(73) Assignee: eBay Inc., San Jose, CA (US)

(21) Appl. No.: 13/692,697

(22) Filed: Dec. 3, 2012

(51) Int. Cl. G06Q 30/02

(52) U.S. Cl. CPC G06Q 30/0251
USPC 705/14.49

(57) ABSTRACT

Methods and systems to publish information associated with products and/or services for sale or auction within a selected private network are described. In some example embodiments, the systems receive product description information associated with an available product or service, identify one or more private networks to which to display the product description information, and publish the product description information within the identified private network or networks.

### TECHNICAL FIELD

This application relates generally to information retrieval, and specifically, to a system and method for publishing information for available products and services within private networks.

### BACKGROUND

General merchandising of items for sale via a network-based merchandising system is well known. Many websites accessible via the Internet are operated as online stores or auctions. These websites enable users to purchase items that may be physical items (e.g., an article of clothing), electronic data items (e.g., a downloadable digital media product), or services to be rendered by an affiliated service provider. To facilitate potential transactions and thereby improve user experiences, some websites provide recommendations and other information associated with displayed items to users of the websites.

### BRIEF DESCRIPTION OF THE DRAWINGS

The present technology is illustrated by way of example, and not by way of limitation, in the figures of the accompanying drawings.

FIG. 1 is a block diagram illustrating a network architecture of a system used to publish information for available products and services within private networks, in some example embodiments.

FIG. 2 is a block diagram illustrating a publication system of available products, in some example embodiments.

FIG. 3 is a flow diagram illustrating a method for publishing information for an available product within a private network, in some example embodiments.

FIG. 4 is a flow diagram illustrating a method for displaying information identifying an available product within a private network, in some example embodiments.

FIGS. 5A-5B are display diagrams illustrating example user interfaces that facilitate the publishing or displaying of product information within a private network, in some example embodiments.

FIG. 6 shows a diagrammatic representation of a machine in the example form of a computer system within which a set of instructions may be executed to cause the machine to perform any one or more of the methodologies discussed herein.

### DETAILED DESCRIPTION

### Overview

Methods and systems to publish information associated with products and/or services for sale or auction within a private network are described. In some example embodiments, the systems receive product description information associated with an available product or service, identify one or more private networks in which to display the product description information, and publish the product description information within the identified private network or networks.

For example, a person wants to sell her car via an online auction site. The online auction site provides a page that enables the seller to enter product description information, such as a title for the listing, photos of the car, text describing features of the car, price information, and so on. Additionally, the online auction site identifies the seller as a member of a few private networks and groups (e.g., is a member of a social network and an employee of a company that supports an Intranet). Before publishing a listing via the online auction site, the site presents user-selectable options to the seller to only publish the listing within the private networks that include the seller as a member, such as within timelines or other online environments supported by the private networks. Thus, the seller is able to control who is able to view or access the published listing that displays the car available for purchase, which enables the online auction site to provide the seller with a level of confidence that inquiries from potential buyers are valid and upstanding, among other benefits.

### Suitable System

In the following description, for purposes of explanation, numerous specific details are set forth in order to provide a thorough understanding of the present disclosure. It may be evident, however, to one skilled in the art that the subject matter of the present disclosure may be practiced without these specific details.

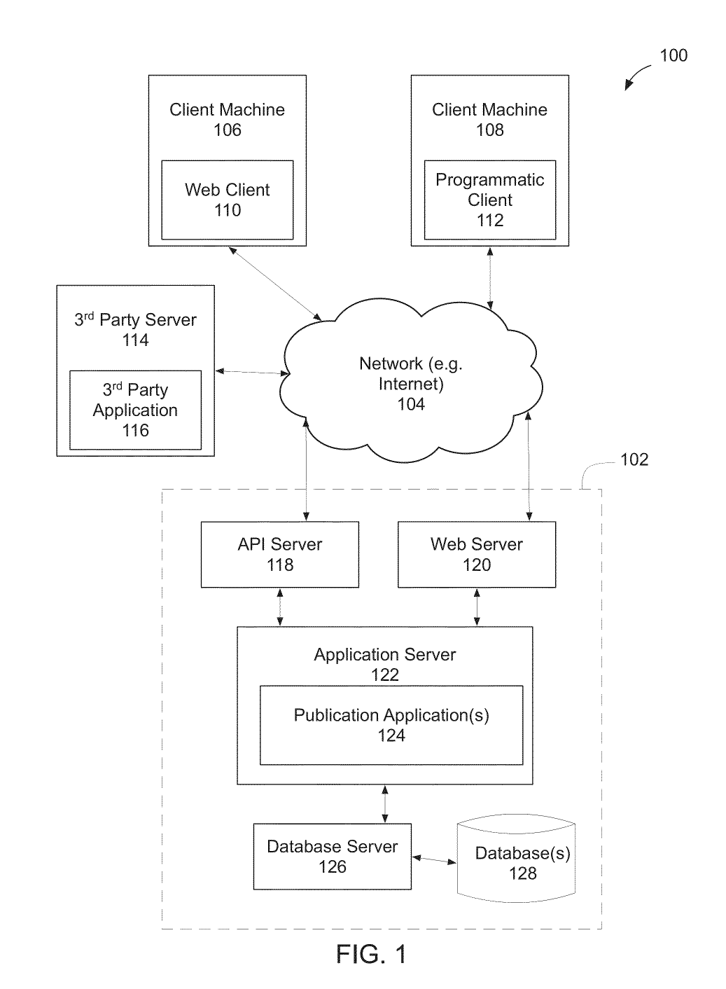

FIG. 1 is a block diagram illustrating a network architecture of a system used to publish information for available products and services within private networks, in some example embodiments. For example, the network system 100 may be a publication/publisher system 102 where clients may communicate and exchange data within the network system 100. The data may pertain to various functions (e.g., selling and purchasing of items) and aspects (e.g., data describing items listed on the publication/publisher system) associated with the network system 100 and its users. Although illustrated herein as a client-server architecture as an example, other example embodiments may include other network architectures, such as a peer-to-peer or distributed network environment.

A data exchange platform, in an example form of a network-based publisher or publishing system 102, may provide server-side functionality, via a network 104 (e.g., the Internet) to one or more clients. The one or more clients may include users that utilize the network system 100 and more specifically, the network-based publisher 102, to exchange data over the network 104. These transactions may include transmitting, receiving (communicating), and processing data to, from, and regarding content and users of the network system 100. The data may include, but are not limited to, content and user data such as feedback data; user reputation values; user profiles; user attributes; product and service reviews; product, service, manufacture, and vendor recommendations and identifiers; product and service listings associated with buyers and sellers; auction bids; influence data; and transaction data, among other things.

In various embodiments, the data exchanges within the network system 100 may be dependent upon user-selected functions available through one or more client or user interfaces (UIs). The UIs may be associated with a client machine, such as a client machine 106 using a web client 110. The web client 110 may be in communication with the network-based publisher 102 via a web server 120. The UIs may also be associated with a client machine 108 using a programmatic client 112, such as a client application, or a third party server 114 hosting a third party application 116. It can be appreciated in various embodiments that the client machine 106, 108, or third party server 114 may be associated with a buyer, a seller, a third party electronic commerce platform, a payment service provider, or a shipping service provider, each in communication with the network-based publisher 102 and optionally each other. The buyers and sellers may be any one of individuals, merchants, or service providers, among other things.

Turning to the network-based publisher 102, an application program interface (API) server 118 and the web server 120 are coupled to, and provide programmatic and web interfaces respectively to, one or more application servers 122. The application servers 122 host one or more publication application(s) 124. The application servers 122 are, in turn, shown to be coupled to one or more database server(s) 126 that facilitate access to one or more database(s) 128.

In some example embodiments, the web server 120 and the API server 118 communicate and receive data pertaining to listings, transactions, and feedback, among other things, via various user input tools. For example, the web server 120 may send and receive data to and from a toolbar or webpage on a browser application (e.g., web client 110) operating on a. client machine (e.g., client machine 106). The API server 118 may send and receive data to and from an application (e.g., programmatic client 112 or third party application 116) running on another client machine (e.g., client machine 108 or third party server 114).

The publication application(s) 124 may provide a number of publisher functions and services (e.g., search, listing, payment, etc.) to users that access the network-based publisher 102. For example, the publication application(s) 124 may provide a number of services and functions to users for listing goods and/or services for sale, searching for goods and services, facilitating transactions, and reviewing and providing feedback about transactions and associated users. Additionally, the publication application(s) 124 may track and store data and metadata relating to listings, transactions, and user interactions with the network-based publisher 102.

FIG. 1 also illustrates a third party application 116 that may execute on the third party server 114 and may have programmatic access to the network-based publisher 102 via the programmatic interface provided by the API server 118. For example, the third party application 116 may use information retrieved from the network-based publisher 102 to support one or more features or functions on a website hosted by the third party. The third party website may, for example, provide one or more listing, feedback, publisher, or payment functions that are supported by the relevant applications of the network-based publisher 102.

While the example network architecture 100 of FIG. 1 employs a client-server architecture, a skilled artisan will recognize that the present disclosure is not limited to such all architecture. The example network architecture 100 can equally well find application in, for example, a distributed or peer-to-peer architecture system.

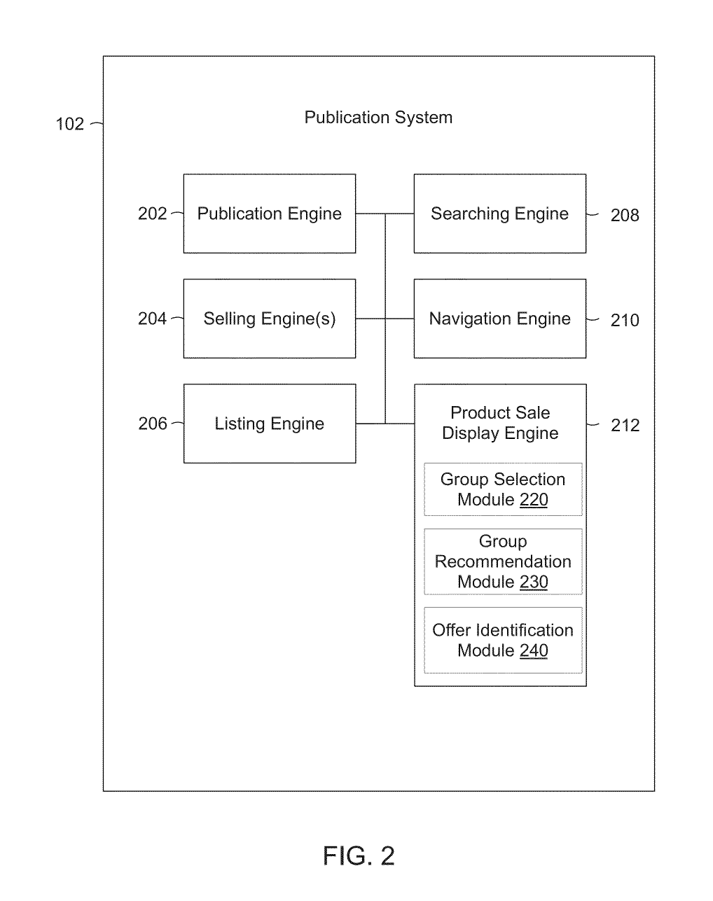

Referring now to FIG. 2, an example block diagram illustrating multiple components that, in some example embodiments, are provided within the publication system 102 of the networked system 100 is shown. The publication system 102 may be hosted on dedicated or shared server machines (not shown) that are communicatively coupled to enable communications between the server machines. The multiple components, themselves, are communicatively coupled (e.g., via appropriate interfaces), either directly or indirectly, to each other and to various data sources, to allow information to be passed between the components or to allow the components to share and access common data. Furthermore, the components may access the one or more database(s) 128 via the one or more database servers 126, both shown in FIG. 1.

In some example embodiments, the publication system 102 comprises a network-based marketplace and provides a number of publishing, listing, and price-setting mechanisms whereby a seller (e.g., business or consumer) may list (or publish information concerning) goods or services for sale, a buyer can search for, express interest in, or indicate a desire to purchase such goods or services, and a price can be set for a transaction pertaining to the goods or services. To this end, the publication system 102 may comprise at least one publication engine 202 and one or more selling engines 204. The publication engine 202 may publish information, such as item listings or product description pages, on the publication system 102. In some example embodiments, the selling engines 204 may comprise one or more auction engines that support auction-format listing and price setting mechanisms (e.g., English, Dutch, Chinese, Double, Reverse auctions, and so on). The various auction engines may also provide a number of features in support of these auction-format listings, such as a reserve price feature whereby a seller may specify a reserve price in connection with a listing and a proxy-bidding feature whereby a bidder may invoke automated proxy bidding. The selling engines 204 may also include fixed price setting engines, among other things.

A listing engine 206 allows sellers to conveniently author listings of items or author publications. In some example embodiments, the listings pertain to goods or services that a user (e.g., a seller) wishes to transact via the publication system 102. Each good or service is associated with a particular category. The listing engine 206 may receive listing data such as title, description, and aspect name/value pairs. Furthermore, each listing for a good or service may be assigned an item identifier. In some example embodiments, a user may create a listing that is an advertisement or other form of information publication. The listing information may then be stored to one or more storage devices coupled to the publication system 102 (e.g., databases 128). Listings also may comprise product descriptions that display a product and information (e.g., product title, specifications, reviews, and so on) associated with the product. In some example embodiments, the product description page may include an aggregation of item listings that correspond to the product described on the product description page.

A searching engine 208 facilitates searching the network-based publication system 102. For example, the searching engine 208 enables keyword queries of listings published via the publication system 102. In some example embodiments, the searching engine 208 receives the keyword queries from a computing device associated with a user and conducts a review of the storage device storing the listing information. The review will enable compilation of a result set of listings that may be sorted and returned to the client device (e.g., client device 106) of the user. The searching engine 208 may record the query (e.g., keywords) and any subsequent user actions and behaviors (e.g., navigations).

A navigation engine 210 enables users to navigate through various categories, catalogs, or inventory data structures according to which listings may be classified within the publication engine 202. For example, the navigation engine 210 allows a user to successively navigate down a category tree comprising a hierarchy of categories until a particular set of listings is reached. Various other navigation applications within the navigation engine 210 may be provided to supplement the searching and browsing applications. The navigation engine 210 may record the various user actions (e.g., clicks) performed by the user in order to navigate down the category tree.

In some example embodiments, a product sale display engine 212 enables a seller of a product and/or provider of a service to determine at what online locations to display information associated with an available product or service for sale. For example, the product sale display engine 212 may facilitate displaying information associated with an available product at online locations associated with one or more private networks or groups, such as social network locations, group message boards, corporate intranets, email groups, micro-blogs, and so on.

In some examples, the product sale display engine 212 may include one or more modules and/or components to perform one or more operations of the product sale display engine 212. The modules may be hardware, software, or a combination of hardware and software, and may be executed by one or more processors. For example, the product sale display engine 212 may include a group selection module 220, a group recommendation module 230, and an offer identification module 240.

In some example embodiments, the group selection module 220 is configured and/or programmed to identify, select, and/or otherwise determine a group of users or network of users (i.e., a private network) at which to display information associated with an available product or service. The group selection module 220 may identify a social network that includes the seller as a member, a group or organization that includes the seller as a member, a company that employs the seller, a micro-blog or web-based organization of followers that includes the seller as a member, and so on.

That is, the group selection module 220 selects a group of users to which to display information identifying a product or service that is available for purchase to the users within the selected group. The group selection module 220 may select users for the group from one or more networks or groups associated with the seller, including:

Users connected to the seller as first degree connections within a social network;

Users connected to the seller as second or third degree connections within a social network;

Users connected to the seller via common membership within a group, club, organization, or other membership based entity;

Users currently or previously employed by the same company that employed or employs the seller;

Users currently or previously enrolled at the same school or university that enrolled or enrolls the seller;

Users that are living or previously lived at a location where the setter lives or previously lived;

Users that share common interests with the seller; and so on.

In some example embodiments, the online site that publishes a listing for the available product or service may, via the group selection module 220, facilitate the selection of a private network or group by providing an option, such as a user-selectable button or element displayed by a product listing page, that enables the seller to identify and/or select a group of users in which to display information associated with the product listing.

In some example embodiments, the group recommendation module 230 is configured and/or programmed to recommend and/or automatically select for a seller a private network or group in which to provide information associated with an available product or service. The group recommendation module 230 may receive description information associated with the available product or service and, based on the information, determine a group of users in which to provide information. For example, the group recommendation module 230 may identify, based on title information, that the available product is a soccer jersey, and select a group of users associated with the seller of the soccer jersey based on the information, such as a group that includes (1) first degree or second degree friends within a social network that indicate an interest in soccer, and (2) first degree or second degree friends within the social network that indicate an interest in fashion, and (3) members of a soccer club that includes the seller as a member.

In some example embodiments, the offer identification module 240 is configured and/or programmed to identify a connection between a buyer or bidder and a seller of a product, such as by displaying an indication of a shared group or network along with a bid or purchase offer for a product. For example, the offer identification module 240 may provide an indication of a shared group, such as information identifying the buyer that is derived from a shared network or group (e.g., a photo from a profile page within the shared network), along with a bid or offer on the available product or service.

Although the various components of the publication engine 202 have been discussed in terms of a variety of individual modules and engines, one skilled in the art will recognize that many of the components can be combined or organized in other ways. Furthermore, not all components of the publication engine 202 have been included FIG. 2. In general, components, protocols, structures, and techniques not directly related to functions of example embodiments (e.g., dispute resolution engine, loyalty promotion engine, reputation engines, listing management engines, account engine) have not been shown or discussed in detail. The description given herein simply provides a variety of example embodiments to aid the reader in an understanding of the systems and methods used herein.

Publishing Information Associated with Products or Services Within Private Networks

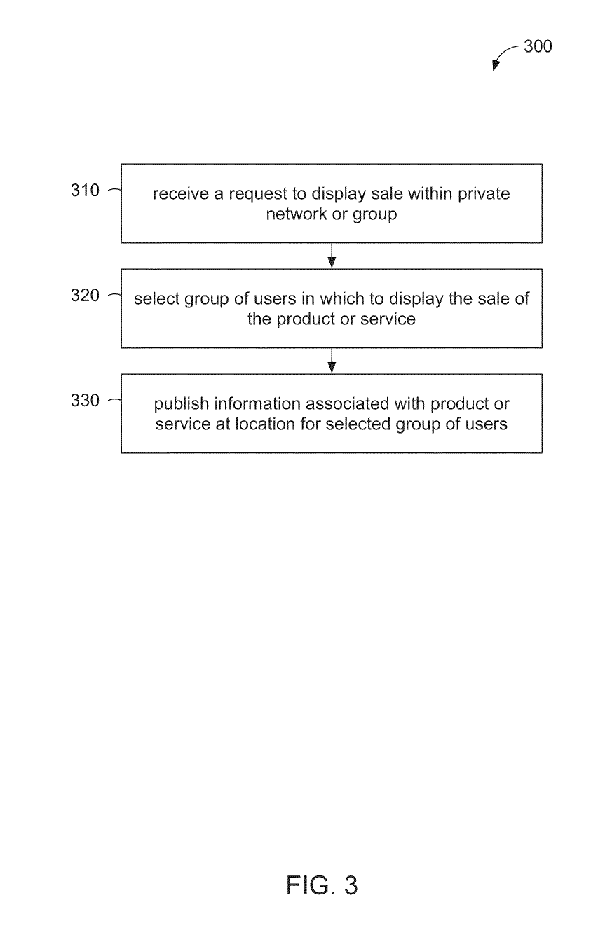

As described herein, the product sale display engine 212 may include modules or components configured to display information or advertising associated with products or services available for purchase via an online retail, auction site, and/or other network-based system, among other things. FIG. 3 is a flow diagram illustrating a method 300 for publishing information for an available product within a private network, in some example embodiments.

In operation 310, the product sale display engine 214 receives information indicating a request to publish information associated with a sale or auction of a product or service to a private network or group of user. For example, an online auction site or online retail site (e.g., an online site that displays online classified advertisements) receives a request to publish a sale of a product or service when a seller selects a button displayed by a product description page associated with the product or service.

In operation 320, the product sale display engine 214 identities and/or selects a group of users in which to display information associated with the sale or auction of the product or service. For example, the group selection module 220 identities a group of users to which to display information advertising or otherwise associated with the product or service.

In some example embodiments, the product sale display engine 214 receives, directly from the seller, an identification of a group of users to which to display information associated with the sale of the product or service. For example, the system may store and/or obtain information that identifies various groups, networks, or other affiliations associated with the seller, and present user-selectable options of one or more of these affiliations. The seller may identify a desired group (e.g. “my Facebook friends”) by selecting that option.

In some example embodiments, the product sale display engine 214 automatically recommends, determines and/or selects a group of users to which to display information associated with the sale of the product or service. The system, via the group recommendation module 230, may recommend or select a group of users based on information associated with a description of a product or service, a location of a seller, and so on. For example, the product sale display engine 214 may identify that a seller of an apartment is located in New York City and select a group of users that includes first and second degree social network connections to the seller that live within or proximate to New York City.

In operation 330, the product sale display engine 214 publishes information associated with the product or service at a location associated with the selected group or network. For example, the publication engine 202 may display information identifying and linking a product description for the available product or service within an online location associated with the selected group or network.

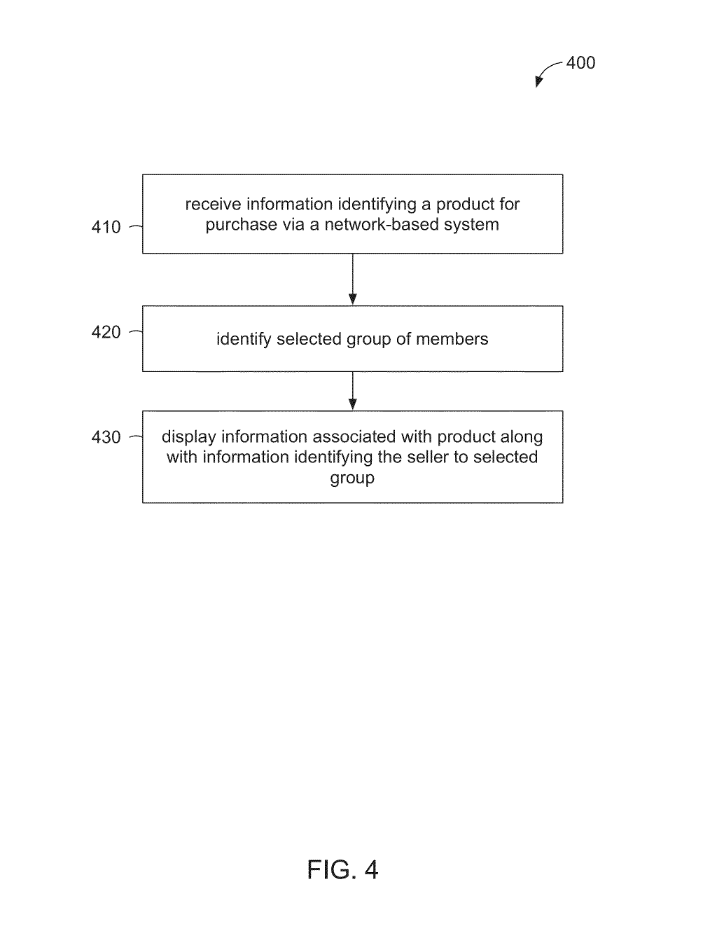

FIG. 4 is a flow diagram illustrating a method 400 for displaying information identifying an available product within a private group or network, in some example embodiments.

In operation 410, the product sale display engine 214 receives information associated with an available product or service. For example, the product sale display engine 214 may receive and publish information to a selected group or network via one or more APIs associated with displaying information to such a location. For example, the product sale display engine 214 may receive description information (e.g., photo, price, rending information, and so on) associated with the sale of the product or service to the location via known APIs, and the online location may utilize such information in order to create a link, advertisement, or other information display within the selected group or location.

In some example embodiments, the product sale display engine 214 may receive information identifying a group of users to which to display the information associated with the available product or service. For example, a social network may receive product description information along with information identifying a subset of members connected to the seller at which to display the information advertising the product or service. This information may identify a type of connection (e.g., first degree, second degree, and so on in which to display the product description information, assigned attributes (e.g., location attributes, interest attributes, experience attributes, and so on) for members selected to view the display of product description information, and so on.

In operation 420, the product sale display engine 214 identifies the selected group of users based on the received information. For example, the product sale display engine 214 may identify a group of members within a social network that are connected to the seller, a group of members that are part of an organization that includes the seller as a member, a group of users that includes users from any number of networks and/or organizations of which the seller is a member, a subset of members that share a network and/or organization of which the seller is a member, and so on.

In operation 430, the product sale display engine 214 displays information identifying the available product or service along with information identifying the seller to the location associated with the selected group or network. For example, the product sale display engine 214 may display product description information that links back to a product page at an online retail site that offers the product or service for sale along with information (e.g., a name, photo, connection information, and so on) identifying the seller of the product or service.

When a user is interested in purchasing or bidding on an available product or service, the product sale display engine 214 may facilitate the presentation of the bid or offer to the seller. In some example embodiments, the product sale display engine 214 may present the bid or offer along with information identifying a relationship, if any, between the buyer and the seller. For example, the offer identification module 240 may obtain information associated with the buyer and/or information associated with a relationship between the buyer and seller, and present this information along with the bid or offer to purchase the available product or service. The relationship may be, for example, a relationship within a social graph, a relationship within a company, and so on.

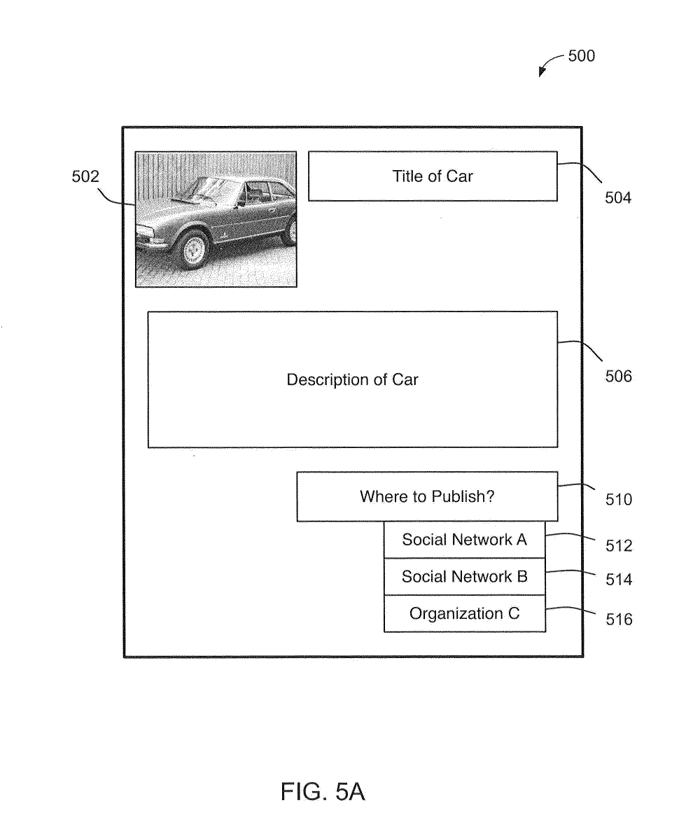

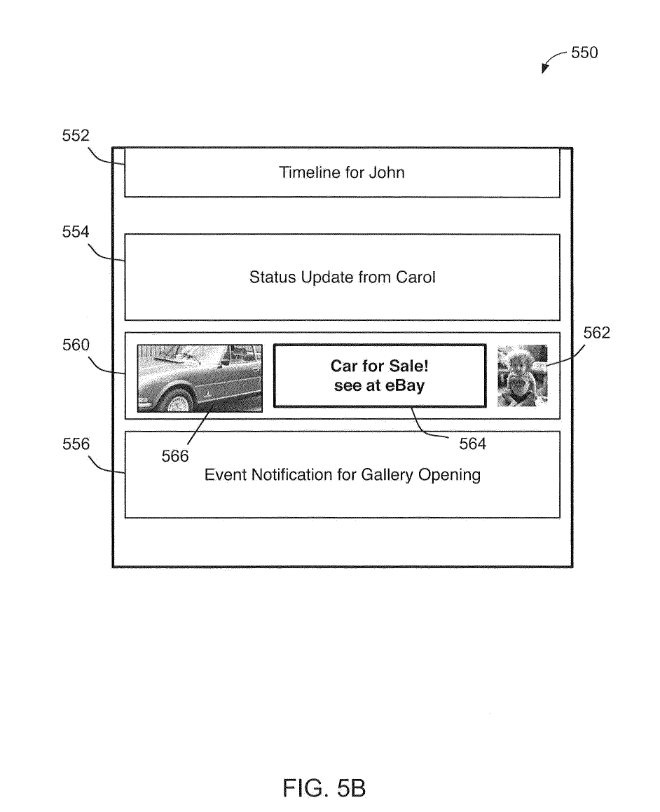

FIGS. 5A-5B provide example user interfaces that illustrate the publication or display of product information within a private network. FIG. 5A presents a user interface 500 that enables a seller of a product to create a product description and/or listing as well as select one or more private networks to which to display information associated with the product. The user interface 500 includes various elements for product description information, such as image information 502, listing title information 504, and listing description information 506. The user interface 500 also includes user-selectable options 510 associated with selecting a private network or group to which to publish, display, and/or otherwise advertise the sale of the product, such as “Social Network A” 512, “Social Network B” 514, “Organization C” 516, and so on. These private networks or groups are related to the seller and determined by, for example, the group selection module 220, based on attributes of the seller. These attributes of the seller may be identified based on a user profile, a user registry, a user affiliation, past transaction history, or any other source that provides seller attributes.

FIG. 5B presents a user interface 550 for a display page 552 (e.g., a timeline or other collection of posts) within a social network for a member. The user interface 550 displays information associated with a product or service available for sale within a private network along with other information associated with the social network. For example, the user interface 550 displays information within a member's timeline 552, such as information 55.4 associated with status updates, information 556 associated with events, and so on, along with information 560 associated with the available product or service. The information 560 associated with the available product or service may include information identifying the seller 562, such as a photo or other information derived from the social network, information 564 describing the product, one or more images 566, and so on. Selection of any of the displayed information may cause a browser or other component displaying the user interface 550 to direct the member of the social network to a product page at a network-based system that is facilitating the sale of the product.

Thus, in some example embodiments, the systems and methods described herein enable a seller of a product or service to determine a group of users to which to sell or offer for sale the product or service, enabling the seller to advertise and sell the product to known or connected people, among other benefits.

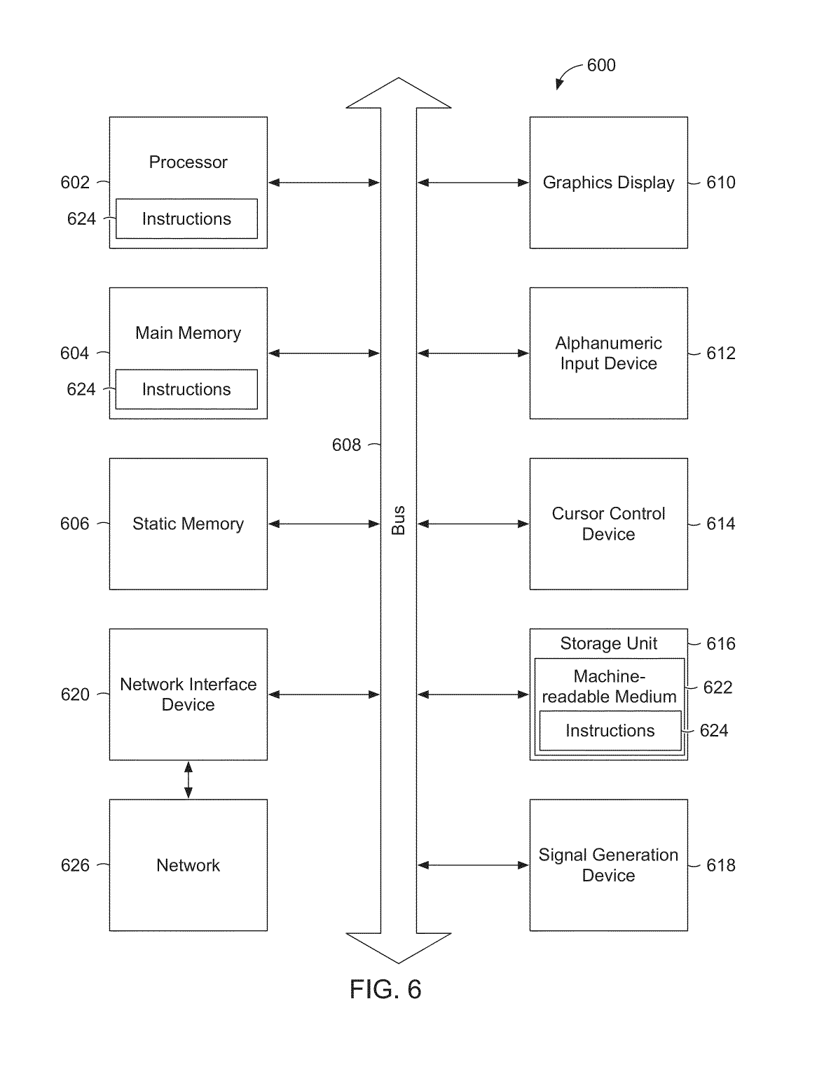

FIG. 6 shows a diagrammatic representation of machine in the exemplary form of a computer system 600 within which a set of instructions, for causing the machine to perform any one or more of the methodologies discussed herein, may be executed. In alternative embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a server computer, a client computer, a personal computer (PC), a tablet PC, a set-top box (STB), a Personal Digital Assistant (PDA), a cellular telephone, a web appliance, a network router, switch or bridge, or any machine capable of executing a set of instructions (sequential or otherwise) that specify actions to be taken by that machine. Further, white only a single machine is illustrated, the term “machine” shall also be taken to include any collection of machines that individually or jointly execute a set (or multiple sets) of instructions to perform any one or more of the methodologies discussed herein.

The example computer system 600 includes a processor 602 (e.g., a central processing unit (CPU) a graphics processing unit (GPU) or both), a main memory 604 and a static memory 606, which communicate with each other via a bus 608. The computer system 600 may further include a video display unit 610 (e.g., a liquid crystal display (LCD) or a cathode ray tube (CRT)). The computer system 600 also includes an alphanumeric input device 612 (e.g., a keyboard), a cursor control device 614 (e.g., a mouse), a disk drive unit 616, a signal generation device 618 (e.g., a speaker) and a network interface device 620.

The disk drive unit 616 includes a machine-readable medium 622 on which is stored one or more sets of instructions (e.g., software 624) embodying any one or more of the methodologies or functions described herein. The software 624 may also reside, completely or at least partially, within the main memory 604 and/or within the processor 602 during execution thereof by the computer system 600, the main memory 604 and the processor 602 also constituting machine-readable media. The software 624 may further be transmitted or received over a network 626 via the network interface device 620.

While the machine-readable medium 622 is shown in an exemplary embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding or carrying a set of instructions for execution by the machine and that cause the machine to perform any one or more of the methodologies of the present disclosure. The term “machine-readable medium” shall accordingly be taken to include, but not be limited to, solid-state memories, optical and magnetic media, and carrier wave signals.

Certain embodiments are described herein as including logic or a number of components, modules, or mechanisms. Modules may constitute either software modules (e.g., code embodied on a machine-readable medium or in a transmission signal) or hardware modules. A “hardware module” is a tangible unit capable of performing certain operations and may be configured or arranged in a certain physical manner. In various example embodiments, one or more computer systems (e.g., a standalone computer system, a client computer system, or a server computer system) or one or more hardware modules of a computer system (e.g., a processor or a group of processors) may be configured by software (e.g., an application or application portion as a hardware module that operates to perform certain operations as described herein.

In some embodiments, a hardware module may be implemented mechanically, electronically, or any suitable combination thereof. For example, a hardware module may include dedicated circuitry or logic that is permanently configured to perform certain operations. For example, a hardware module may be a special-purpose processor, such as a field programmable gate array (FPGA) or an ASIC. A hardware module may also include programmable logic or circuitry that is temporarily configured by software to perform certain operations. For example, a hardware module may include software encompassed within a general-purpose processor or other programmable processor. It will be appreciated that the decision to implement a hardware module mechanically, in dedicated and permanently configured circuitry, or in temporarily configured circuitry (e.g., configured by software) may e driven by cost and time considerations.

Accordingly, the phrase “hardware module” should be understood to encompass a tangible entity, be that an entity that is physically constructed, permanently configured (e.g., hardwired), or temporarily configured (e.g., programmed)to operate in a certain manner or to perform certain operations described herein. As used herein, “hardware-implemented module” refers to a hardware module. Considering embodiments in which hardware modules are temporarily configured (e.g., programmed), each of the hardware modules need not be configured or instantiated at any one instance in time. For example, where a hardware module comprises a general-purpose processor configured by software to become a special-purpose processor, the general-purpose processor may be configured as respectively different special-purpose processors (e.g., comprising different hardware modules) at different times. Software may accordingly configure a processor, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple hardware modules exist contemporaneously, communications may be achieved through signal transmission (e.g., over appropriate circuits and buses) between or among two or more of the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

Although the present disclosure has been described with reference to specific exemplary embodiments, it may be evident that various modifications and changes may be made to these embodiments without departing from the broader spirit and scope of the disclosure. Accordingly, the specification and drawings are to be regarded in an illustrative rather than a restrictive sense.

The accompanying drawings that form a part hereof, show by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

The preceding technical disclosure is intended to be illustrative, and not restrictive. For example, the above-described embodiments (or one or more aspects thereof) may be used in combination with each other. Other embodiments will be apparent to those of skill in the art upon reviewing the above description.

In this document, the terms “a” or “an” are used, as is common in patent documents, to include one or more than one. In this document, the term “or” is used to refer to a nonexclusive or, such that “A or B” includes “A but not B,” “B but not A,” and “A and B,” unless otherwise indicated. Furthermore, all publications, patents, and patent documents referred to in this document are incorporated by reference herein in their entirety, as though individually incorporated by reference. In the event of inconsistent usages between this document and those documents so incorporated by reference, the usage in the incorporated reference(s) should be considered supplementary to that of this document; for irreconcilable inconsistencies, the usage in this document controls.

What is claimed is:

1. A computer-implemented method, comprising:
receiving, from a seller, information indicating a product is available for sale at a network-based system;
identifying a private group of users associated with the seller to which to advertise the product to be sold via the network-based system; and
presenting information identifying the product to be sold to the identified private group of users via an online location associated with the identified private group of users.

2. The method of claim 1, wherein the private group of users includes the seller of the product available for sale at the network-based system.

3. The method of claim 1, wherein identifying the private group of users to which to advertise the product to be sold via the network-based system includes identifying a group of users that are members of a social network and connected within the social network to the seller of the product available for sale at the network-based system.

4. The method of claim 1, wherein identifying the private group of users to which to advertise the product to be sold via the network-based system includes identifying a group of users that includes first degree connections within a social network with the seller of the product available for sale and that includes second degree connections within the social network with the seller of the product available for sale.

5. The method of claim 1, wherein the identifying the private group of users to which to advertise the product to be sold via the network-based system includes identifying a group of colleagues employed by a company that employs the seller of the product available for sale at the network-based system; and wherein the online location associated with the identified private group of users includes a private Intranet associated with the company.

6. The method of claim 1, wherein receiving information indicating a product is available for sale at a network-based system includes receiving information from an online auction site.

7. The method of claim 1, wherein receiving information indicating a product is available for sale at a network-based system includes receiving information from an online site of classified advertisements.

8. The method of claim 1, wherein identifying a private group of users to which to advertise the product to be sold via the network-based system includes automatically identifying the private group of users based on information associated with a description of the product available for sale.

9. The method of claim 1, wherein receiving information indicating a product is available for sale at a network-based system includes receiving information associated with a description of the product available for sale; and wherein identifying the private group of users to which to advertise the product to be sold via the network-based system includes identifying the private group of users based, at least in part, on the information associated with the description of the product available for sale.

10. The method of claim 1, wherein presenting information identifying the product to be sold to the identified private group of users includes displaying information identifying a relationship between the seller of the product to be sold and the identified private group of users.

11. The method of claim 1, wherein presenting information identifying the product to be sold to the identified private group of users includes displaying information that includes a link to a product page supported by the network-based system that facilitates a purchase of the product available for sale from the network-based system.

12. A network-based system, comprising:
a publication engine that is configured to publish a product listing that presents description information associated with a product available for sale via the network-based system; and
a group selection module that is configured to determine a group of users within a private network that includes a seller of the product available for sale as a member to which to display the product listing.

13. The system of claim 12, wherein the group selection module is configured to select the group of users that are first-degree connections with the seller within a private network.

14. The system of claim 12, wherein the group selection module is configured to select the group of users that are first-degree or second-degree connections with the member within the private network.

15. The system of claim 12, wherein the group selection module is configured to select the group of users that includes users indicating an interest that is associated with the product available for sale.

16. The system of claim 12, wherein the group selection module is configured to select the group of users that includes users at a same location as that of the seller of the product available for sale.

17. The system of claim 12, wherein the group selection module is configured to receive input from the seller of the product available for sale identifying a selection of the private network.

18. A computer-readable storage medium whose contents, when executed by a computing system, cause the computing system to perform operations comprising:
receiving information associated with a product for purchase via an online auction site;
identifying a group of users affiliated with a user selling the product via the online auction site; and
publishing information indicating the product for purchase and information identifying the user selling the product within a web site associated with the group of users.

19. The computer-readable storage medium of claim 18, wherein the group of users is a group of users connected to the user selling the product via a social network.

20. The computer-readable storage medium of claim 18, wherein the group of users is a group of users that are members of an organization of which the user selling the product is a member.
